(19) United States
(12) Patent Application Publication
(10) Pub. No.: US 2026/0371041 A1
(43) Pub. Date: Nov. 19, 2026

(54) ENABLING SENSING AND SENSING FUSION FOR A METAVERSE SERVICE IN A WIRELESS COMMUNICATION SYSTEM

(71) Applicant: LENOVO (SINGAPORE) PTE. LTD., Singapore (SG)

(72) Inventors: Emmanouil PATEROMICHELAKIS, Viersen (DE); Dimitrios KARAMPATSIS, Ruislip (GB)

(21) Appl. No.: 19/155,415

(22) PCT Filed: Mar. 24, 2023
(86) PCT No.: PCT/EP2023/057620

§ 371 Date: Aug. 11, 2025

(30) Foreign Application Priority Data
Feb. 17, 2023 (GR) 20230100136

(51) Int. Cl. H04W 4/38; H04W 8/22; H04W 64/00

(52) U.S. Cl. CPC H04W 4/38; H04W 8/22; H04W 64/00

(57) ABSTRACT

There is provided, a method in an apparatus in a wireless communication system. The method comprises receiving from a consumer entity, a service request; determining, based on the service request, a requirement for sensing one or more target objects in a target area; selecting, based on the requirement, at least one device from a plurality of devices; collecting, from the at least one device, sensing data of the one or more target objects in the target area; processing the sensing data; and then transmitting the sensing data to the consumer entity.

### FIELD

The subject matter disclosed herein relates generally to the field of implementing the enabling of sensing and sensing fusion for a metaverse service in a wireless communication system. This document defines an apparatus and associated method in a wireless communication system, and further defines a user equipment device and associated method in a wireless communication system.

### INTRODUCTION

The metaverse is an open, shared, and persistent virtual world that offers access to the three dimensional (3D) virtual spaces, solutions, and environments created by users. The metaverse is a digital reality that combines aspects of social media, online gaming, augmented reality (AR), virtual reality (VR), and cryptocurrencies to allow users to interact virtually. As the metaverse grows, it will create online spaces where user interactions are more multidimensional than current technology supports. Instead of just viewing digital content, users in the metaverse will be able to immerse themselves in a space where the digital and physical worlds converge.

Some key differentiating factors between Extended Reality (XR) and Metaverse is that everything the user creates and owns in the metaverse is his asset, whether it is a piece of virtual real estate or an artifact. The metaverse confers the privileges of complete ownership on users. Moreover, the persistency factor is very important since even if a user exits the metaverse, their respective digital avatar would still be in the metaverse-it would run normally with other users engaging and interacting with the metaverse.

The potential requirements for localized metaverse services are relevant for the third-generation partnership project (3GPP).

### SUMMARY

The use cases and potential requirements for localized metaverse services include a mobile metaverse based selective multi-modal feedback service, a mobile metaverse for fifth generation (5G)-enabled traffic flow simulation and situational awareness, and a spatial mapping and localization service enabler.

A mobile metaverse based multi-modal feedback service describes a case of multi-physical entities or their digital avatars interacting with each other. New feedback modalities are also introduced in this use case to satisfy new scenarios and requirements in the mobile metaverse. Note that mobile metaverse is a cyberspace parallel to the real world, which makes the virtual world more real and makes the real world richer. The service should better utilize different feedback cues and achieve multi-modal feedback cues to adapt to different scenarios, and satisfy the accuracy of the task and user experience, for instance. Further modalities can be explored to meet more immersion requirements of the physical entities in the real world such as smell and taste. To realize a more immersive requirement of different scenarios in the mobile metaverse, it is important to explore these temporal in-sync or out-of-sync boundaries for audio, video, haptic, scent, taste, for instance.

A mobile metaverse for 5G-enabled traffic flow simulation and situational awareness is a use that where, with the support of the 5G system, real-time information and data about real objects can be delivered. For instance, the virtual objects of a road infrastructure and traffic participants-including vulnerable road users-can form a smart transport metaverse. Then real-time processing & computing can be conducted to support traffic simulation and also situational awareness and real time path guidance and real-time safety, or security alerts can be generated for inter-connected vehicles (ICVs) as well as the driver and passengers. To support traffic flow simulation and situational awareness service, the 5G network needs to provide low latency, high data rate and high reliability transmission, and in addition, the 5G network may also need to be further enhanced to meet the service requirements for 5G-enabled traffic flow simulation and situation awareness. Meanwhile, in addition to the real objects which may host the user equipment (UE) for a cellular system, their corresponding virtual objects are also capable of interacting with each other and interacting with physical objects via the 5G system.

In the spatial mapping and localization service enabler use case, the service provider or operator needs to provide and use spatial map information, i.e. a 3D map of indoor or outdoor environment. This use case considers how a spatial map can be created and employed, both as service enablers. The creation and maintenance of the spatial map is referred to as a spatial mapping service and the employment of the map to identify the customer's localization is termed as a spatial localization service.

Spatial mapping will classify objects into modelling and tracking of stationary and moving objects. For a stationary object, spatial mapping has to estimate the number of objects, type of object and position. Whereas for moving objects, spatial mapping has to determine the position, type of object, direction, and speed. Once the spatial mapping service has sufficient information, it has to map all the stationary and moving objects related to a UE's environment. This information can be provided to the UE, service providers and surrounding subscribed users.

It is a hard task to perform the mapping of, for instance, an entire city, using a vehicle by traversing various roads and spaces. It also requires lots of time and effort (for data conversion, as one example) if the work is performed offline. If multiple capturing devices are used in parallel, the spatial map data in the same location could be synthesized over the different cameras and input devices to generate the spatial map. A mobile capturing device, vehicle or robot, used to capture the sensed data for the mapping, may be equipped with multiple stereo/mono red-green-blue (RGB) cameras and multiple light detection and ranging (LiDAR) sensors to sense/capture various qualities of images and depth information of the environments. As an example, a mobile indoor robot may be equipped with two LiDAR sensors, six industrial cameras and four smartphone cameras.

For all the described use cases and other scenarios, sensor data is required at the metaverse service provider side, and this may include sensor data from multiple sources and multiple sensor technologies. The variety of sensing methods and sensor technologies that can be used relate to a device's capabilities. These include non-3GPP-based sensors like radar, camera, LiDAR sensors, and ultra-wideband (UWB) sensors, in addition to new radio (NR)-based sensing, and the UE and base station (BS) sensing for stationary and moving objects around a UE. The latter may include methods such as time-difference-of-arrival (TDoA), angle-of-arrival (AoA), angle-of-departure (AoD) measurements, and received signal strength indications (RSSI), for instance.

In addition, there are limitations of devices (e.g. low power nodes) for performing sensing processing, access limitations (bandwidth, latency) for providing the sensing outputs via, for example, Uu interfaces, and also further processing requirements to fuse/combine sensing data from multiple sources to derive more useful information for a given use case e.g. a spatial map. Different application services may also have different requirements in terms of required granularity and accuracy of sensing and the related sensing/sensed data. By way of example, an uplink key performance indicator (KPI) for 3D LIDAR may be 30 Megabits per second (Mbps), a similar KPI for an industrial RGB camera uplink may be 16~800 Mbps, and a KPI for a smart phone camera uplink may be 4~200 Mbps. There also needs to be a way to make the sensing communication optimal so as to avoid wasting network resources.

Certain problems exist with the provision of sensing enablement for metaverse services. One such problem is how to configure sensors/sensing technologies to be used by one or more devices at a target service area for a particular metaverse service. Another problem is how to perform sensing fusion to meeting the metaverse service requirements. A further problem is how to ensure efficient use of the network resources and have minimum impact on the device side (sensing/sensor source) while performing sensing fusion.

Disclosed herein are procedures for enabling sensing and sensing fusion for a metaverse service in a wireless communication system. Said procedures may be implemented by an apparatus in a wireless communication system, a method in an apparatus in a wireless communication system, a user equipment device in a wireless communication system, and a method in a user equipment device in a wireless communication system. Said procedures provide a method for determining the sensing requirement and the translation to sensing needs, for an XR/AI/metaverse application.

There is provided apparatus in a wireless communication system, comprising a processor and a memory coupled with the processor, the processor configured to cause the apparatus to: receive from a consumer entity, a service request; determine, based on the service request, a requirement for sensing one or more target objects in a target area; select, based on the requirement, at least one device from a plurality of devices; collect, from the at least one device, sensing data of the one or more target objects in the target area; process the sensing data; and then transmit the sensing data to the consumer entity.

There is further provided, a user equipment device in a wireless communication system, comprising a processor; and a memory coupled with the processor, the processor configured to cause the user equipment device to: receive, from an apparatus in the wireless communication system, a query requesting sensing capabilities; determine, based on the query, one or more sensing capabilities of the user equipment device and/or of one or more connected applications of the user equipment device; and then transmit, to the apparatus, a query response, wherein the query response comprises the determined one or more sensing capabilities.

There is further provided, a method in an apparatus in a wireless communication system, the method comprising: receiving from a consumer entity, a service request; determining, based on the service request, a requirement for sensing one or more target objects in a target area; selecting, based on the requirement, at least one device from a plurality of devices; collecting, from the at least one device, sensing data of the one or more target objects in the target area; processing the sensing data; and then transmitting the sensing data to the consumer entity.

There is further provided, a method in a user equipment device, the user equipment device in a wireless communication system, the method comprising: receiving, from an apparatus in the wireless communication system, a query requesting sensing capabilities; determining, based on the query, one or more sensing capabilities of the user equipment device and/or of one or more connected applications of the user equipment device; and then transmitting, to the apparatus, a query response, wherein the query response comprises the determined one or more sensing capabilities.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for enabling of sensing and sensing fusion for a metaverse service in a wireless communication system, will now be described, by way of example only, with reference to the accompanying drawings, in which:

FIG. 1 illustrates an embodiment of a wireless communication system;

FIG. 2 illustrates an embodiment of a user equipment apparatus/device;

FIG. 3 illustrates an embodiment of a network node;

FIG. 4 illustrates an example of a deployment of a mobile metaverse based selective multi-modal feedback service;

FIG. 5 illustrates an example scenario of 5G-enabled traffic flow simulation and situational awareness;

FIG. 6 illustrates an embodiment of a deployment of an apparatus/method for determining a sensing requirement and translating the requirement to sensing needs;

FIG. 7 illustrates an embodiment of a method in an apparatus in a wireless communication system;

FIG. 8 illustrates an embodiment of a method in a user equipment device in a wireless communication system;

FIG. 9 illustrates an embodiment of sensing enablement for metaverse/AI/XR applications; and

FIG. 10 illustrates an embodiment of sensing integration for a spatial mapping enablement service.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list.

For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

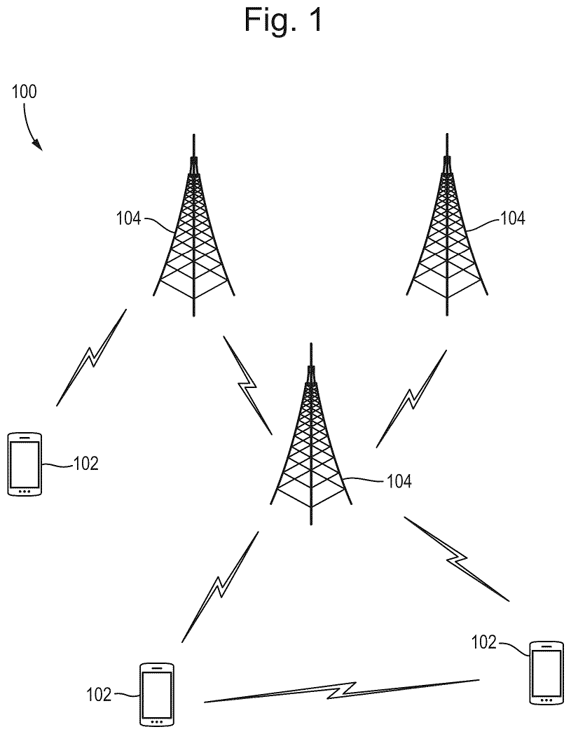

FIG. 1 depicts an embodiment of a wireless communication system 100 for the enabling of sensing and sensing fusion for a metaverse service in a wireless communication system. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

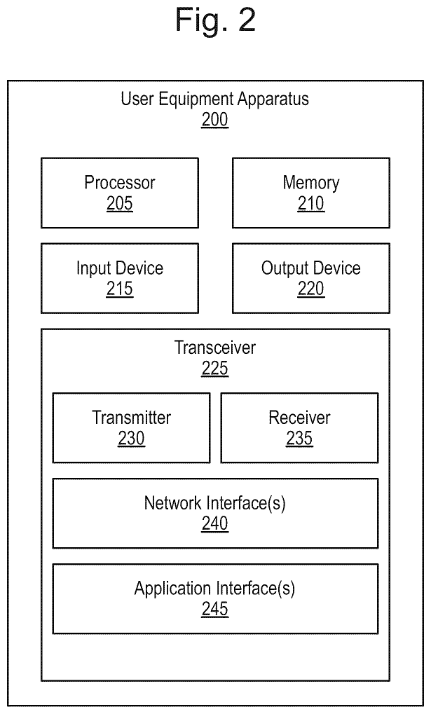

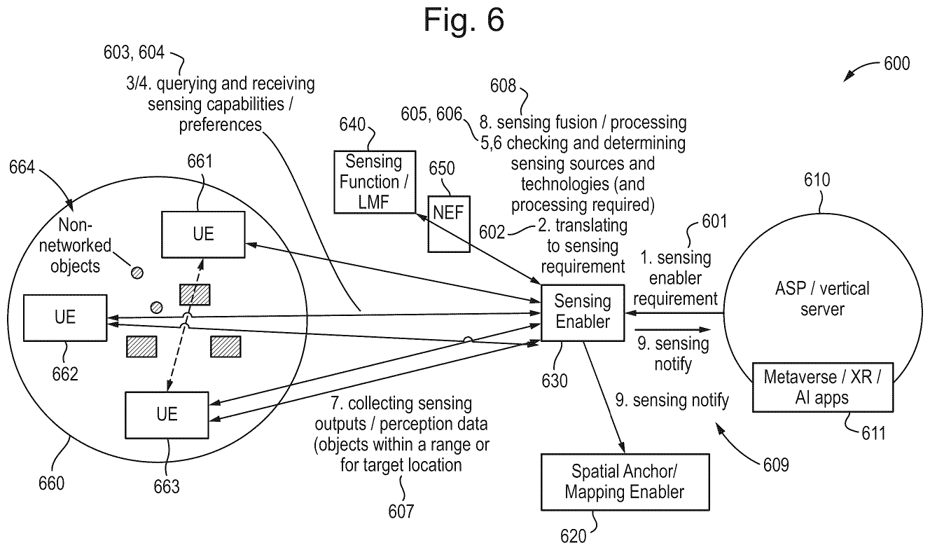

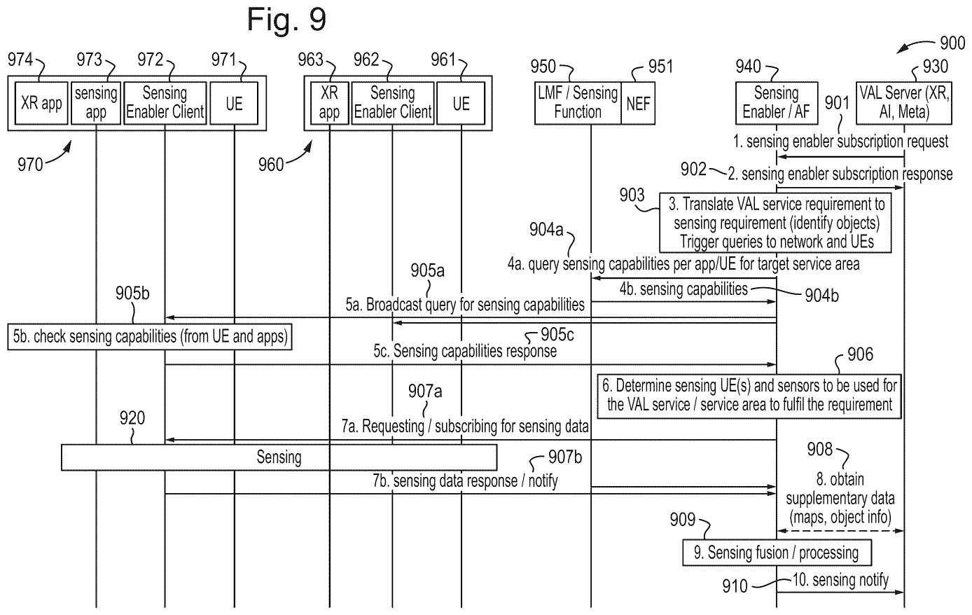

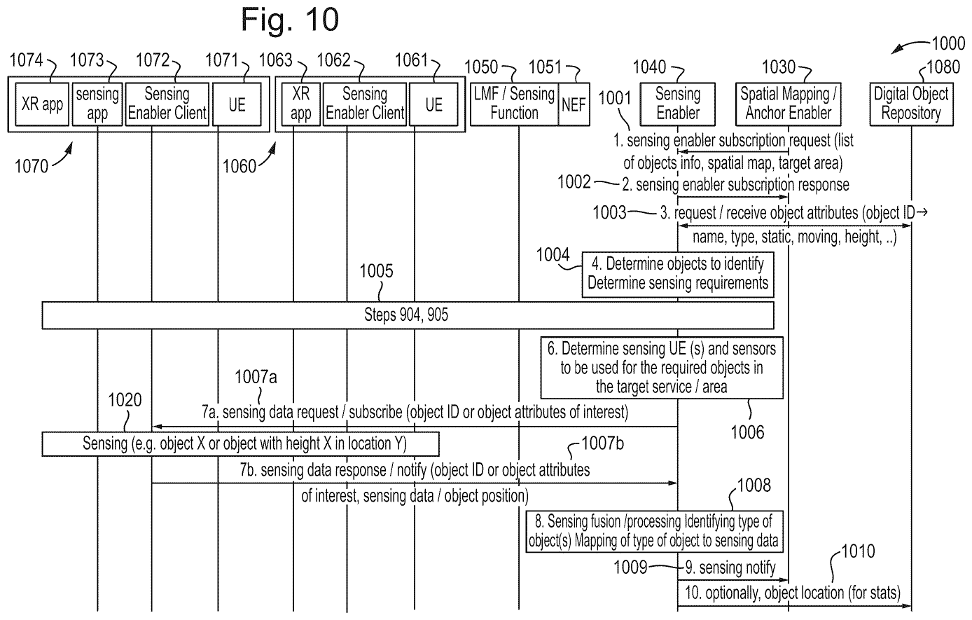

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 may comprise a UE 661, 662 or 663 of FIG. 6, it may comprise a UE 961 or 971 of FIG. 9, or it may comprise a UE 1061 or 1071 of FIG. 10. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communication network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

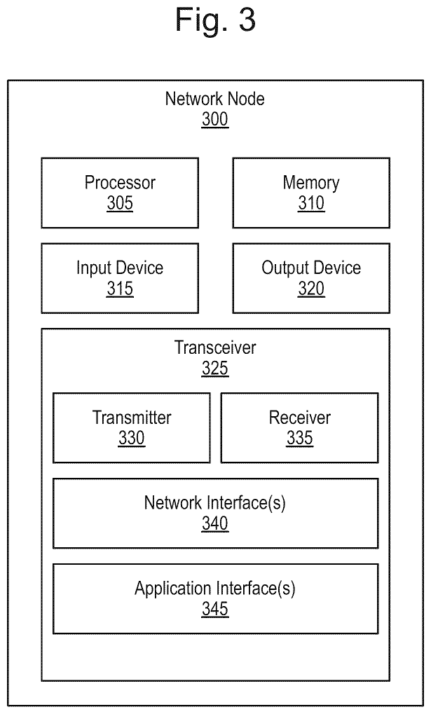

FIG. 3 depicts further details of the network node 300 that may be used for implementing the methods described herein. The network node 300 may be one implementation of an entity in the wireless communication network, e.g. in one or more of the wireless communication networks described herein. The network node 300 may comprise a sensing enabler entity/function/server 630 of FIG. 6, a sensing enabler entity/function/server 940 of FIG. 9 or a sensing enabler entity/function/server 1040 of FIG. 10. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

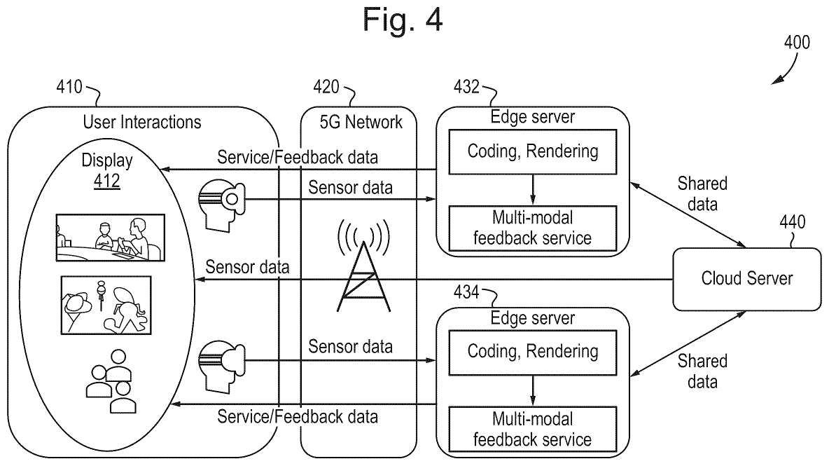

FIG. 4 illustrates an example of a deployment of a mobile metaverse based selective multi-modal feedback service. FIG. 4 illustrates said multi-modal feedback service implemented in a wireless communication network. User interactions 410 with a user equipment having a display 412 are captured as sensor data which is sent via a 5G network 420 to one or more edge servers 432, 434. The user equipment is arranged to run an application for allowing a user to interact with the metaverse. Each Edge server 432, 434 may provide coding and rendering services and multi-modal feedback service. The edge server 432, 434 sends service data and/or feedback data back to the user equipment. The edge server 432, 434 sends shared data to a cloud server 440. A mobile metaverse based multi-modal feedback service may be deployed at the edge/cloud server 432, 434, 440 for different scenarios. During the application running period, the physical entities of the wireless communication network may deliver an immersive experience to the users via their avatars, and the multi-modal feedback data may be exchanged with each other, whether the physical entities are in proximity or non-proximity. FIG. 4 illustrates how the multi-modal feedback service is applied in the mobile metaverse, and the major impact on 3GPP is whether and how 5GS can be used to better utilize different feedback cues and achieve multi-modal feedback cues concerning the experiences of the multi-physical entities.

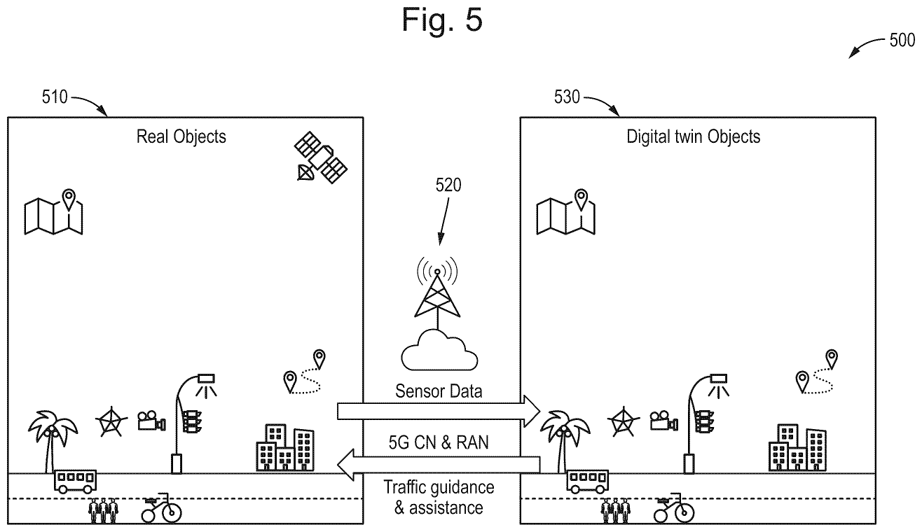

FIG. 5 illustrates a 5G-enabled traffic flow simulation with situational awareness. With the support of 5GS, real-time information and data about the real objects can be delivered to virtual objects in the metaverse. FIG. 5 shows a plurality of real objects 510, and a virtual world comprising a plurality of digital twin objects 530. A wireless communication network 520 carries sensor data from the real objects 510 and delivers this to the digital twin objects 530. The wireless communication network 520 delivers situational information from the digital twin objects 530 in the virtual space back to the real objects 510. Such situational information may comprise traffic guidance and assistance data. In this way, the road infrastructure and traffic participants including vulnerable road users can form a smart transport metaverse. Then real-time processing and computing can be conducted to support traffic simulation and also situational awareness and real time path guidance and real-time safety, or security alerts can be generated for ICVs as well as the driver and passengers.

To support traffic flow simulation and situational awareness service, the 5G network 520 needs to provide low latency, high data rate and high reliability transmission, and in addition, the 5G network 520 may also need to be further enhanced to meet the service requirements for 5G-enabled traffic flow simulation and situation awareness. Meanwhile, in addition to the real objects 510 which may host the UE for a cellular system, their corresponding virtual objects 530 are also capable of interacting with each other and interact with physical objects 510 via 5GS.

As used herein, sensing fusion/sensing data fusion comprises the combining or processing of sensing data/measurements from a plurality of sensors, and providing therefrom an output that is the outcome of such combining or processing. FIG. 6 illustrates an embodiment 600 of a deployment of an apparatus/method for determining a sensing requirement, which may include sensing fusion, and translating the requirement to sensing needs for an XR/AI/Metaverse application 611. The solution comprises steps to be performed at a Service Enabler Unit 630.

In a first step 601, a service requirement is obtained from an XR/AI/Metaverse application 611, illustrated in the Figure with an ASAP/vertical server 610. This requirement includes the needed QoS/QoE for the service, the role of the service enabler to provide sensing data or fused sensing data, or the role of the service enabler to provide a value-added service related to sensing (for example a spatial mapping service).

A further step 602 involves translating the service requirement to a sensing requirement.

A further step 603 involves sending a query to all (or a subset of) UEs 661, 662, 663, supporting the application 611, or all UEs 661, 662, 663, in a given area 660 (which are enabler-aware), for the capabilities and preferences related to sensing both from lower layers (NR-based sensing, as an example of 3GPP/cellular based sensing) and non-3GPP/application specific layer (radar, camera and LIDAR sensors, for instance). This may also include information on the battery/power status for a given UE 661, 662, 663. This step 603 may also include the query to a network function relevant to sensing/localization for the target service area 660, such as querying a sensing function/LMF 640 via a NEF 650. The given area 660 also contains non-network objects 664.

A further step 604 involves receiving the requested VAL UE 661, 662, 663/user capabilities and preferences.

A further step 605 involves checking the feasibility of fulfilling sensing fusion by evaluating a cost for the network and service provider based on the sensing requirement. This cost includes the communication layer and the UE 661, 662, 663, impact and limitations (e.g., bandwidth needs, power constraints etc).

A further step 606 involves determining the UEs 661, 662, 663 to support the sensing fusion and the sensors to be used (3GPP, non-3GPP) per UE 661, 662, 663, as well as the processing/fusion needed.

A further step 607 involves collecting sensing data/perception data (objects within a range for target location) based on the determination in step 606.

A further step 608 involves performing sensing fusion/processing and/or using the outputs for the value-added service (e.g. spatial mapping service). Optionally supplementary data about the environment may be obtained, for example high definition (HD) maps/spatial maps for the target area 660. Furthermore, the step 608 may involve performing object recognition and 3D representation.

A further step 609 then involves sending the sensing data or service enablement data to the consumer XR/AI/Metaverse application 611 or to other entities which consume this service (based on subscription) e.g. the spatial mapping enabler 620.

The disclosure herein provides for an apparatus in a wireless communication system, comprising a processor and a memory coupled with the processor, the processor configured to cause the apparatus to receive from a consumer entity, a service request; determine, based on the service request, a requirement for sensing one or more target objects in a target area; select, based on the requirement, at least one device from a plurality of devices; collect, from the at least one device, sensing data of the one or more target objects in the target area; process the sensing data; and then transmit the sensing data to the consumer entity.

In some embodiments, the service request comprises: a vertical application layer, VAL, server identifier or application server identifier or a spatial mapping enabler, SME, identifier; a VAL service identifier of application service identifier; a sensing event identifier; one or more VAL user equipment, UE, identifiers/addresses within a VAL service; the target area; a time validity/horizon; one or more quality of service requirements; one or more sensing requirements; identifiers for the one or more target objects to be sensed; an event reporting criteria; and/or a permission, restriction and/or preference for a sensor technology.

In some embodiments, the consumer entity is a VAL server.

In some embodiments, the consumer entity is a spatial mapping enabler, SME, or a spatial anchor enabler, SAE.

In some embodiments, the service request further comprises at least one of: a spatial mapping of, or data for spatially mapping, the target area; a request for sensor data for a particular user; a positional and/or orientation data for a particular user; and/or a request for sensor data related to a set of spatial anchors.

In some embodiments, the processor is further configured to cause the apparatus to obtain, from an object repository, one or more attributes relating to the one or more target objects in the target area.

In some embodiments, the processor is further configured to cause the apparatus to transmit, to the object repository, a mapping of the sensing data to the one or more target objects.

In some embodiments, the processor is further configured to cause the apparatus to determine sensing capabilities of the plurality of devices, wherein the sensing capabilities relate to sensing the one or more target objects in the target area; and select the at least one device, based also on the sensing capabilities.

In some embodiments, the sensing capabilities comprise respective sensing technologies of the plurality of devices, and wherein the processor is further configured in causing the apparatus to select the at least one device, to cause the apparatus to determine a sensing technology for sensing the one or more target objects in the target area. In some embodiments, the determined sensing technologies may be one or more sensor types, such as LIDAR or visible or other waveband camera.

In some embodiments, the processor is further configured to cause the apparatus to determine the sensing capabilities of the plurality of devices by causing the apparatus to: query a first network function for the sensing capabilities of the plurality of devices.

In some embodiments, the first network function is a network function selected from the list of network functions consisting of: a location management function, LMF; and a sensing function.

In some embodiments, the processor is further configured to cause the apparatus to determine the sensing capabilities of the plurality of devices by causing the apparatus to: transmit a query to the plurality of devices, the query requesting the sensing capabilities of the plurality of devices; and receive a query response from one or more of the devices in the plurality of devices.

In some embodiments, the query to the plurality of devices, comprises: a VAL service ID or application service ID; one or more sensing requirements; identifiers for the one or more target objects to be sensed; a sensing preferences request; a device battery/context request; a target area; a time of interest; and/or a time to wait. The sensing requirements may be non-3GPP or 3GPP sensing requirements.

In some embodiments, the processor is further configured to cause the apparatus to determine a feasibility of fulfilling the service request based on the sensing capabilities of the plurality of devices.

In some embodiments, the sensing data comprises: one or more identifiers related to the one or more target objects; a location related to the one or more target objects; a mobility related to the one or more target objects; an orientation related to the one or more target objects; a dimensional information related to the one or more target objects; and/or a material information related to the one or more target objects.

In some embodiments, the processor is further configured to cause the apparatus to process the sensed data by performing an abstraction, integration and/or fusion of the sensed data.

In some embodiments the processor is further configured to cause the apparatus to: collect supplementary data related to the target area; and perform the abstraction, integration and/or fusion using both the sensed data the supplementary data. The supplementary data may be from the application layer, and may comprise, for instance, HD maps or spatial maps.

In some embodiments, the processor is further configured to cause the apparatus to process the sensed data by performing object recognition.

The sensed data could also, in some embodiments, be provided to another entity that is subscribed for receiving sensed data of the one or more target objects, or of the target area.

In some embodiments, the apparatus may be a sensing enablement server. The service request may be a subscription request. The collection of the sensing data may be via a request/response or a subscribe/notify procedure. Furthermore, the determining of the sensing capabilities includes embodiments wherein the apparatus actively probes or interrogates or queries other network entities or user equipment devices, for the sensing capabilities, but also includes embodiments wherein the sensing capabilities are already known to the apparatus (i.e. sensing capabilities of devices may have been pre-provisioned to the apparatus, or, may be provided in the service request, for instance). Furthermore, in some embodiments, the service request may relate to a metaverse/XR requirement and/or related application.

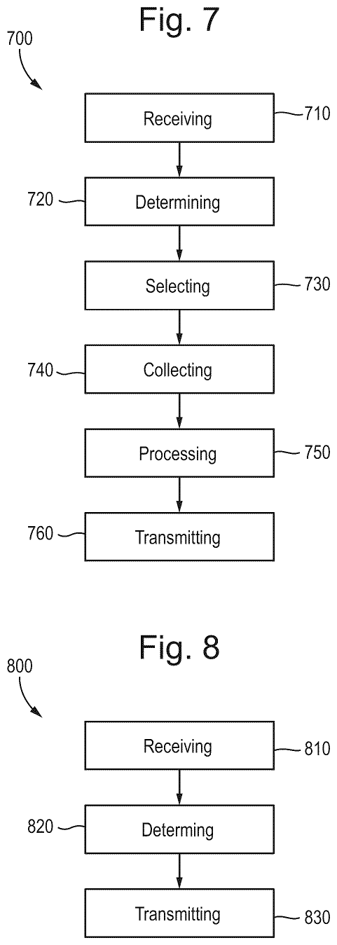

FIG. 7 illustrates an embodiment 700 of a method in an apparatus in a wireless communication system.

A first step 710 comprises receiving from a consumer entity, a service request.

A further step 720 comprises determining, based on the service request, a requirement for sensing one or more target objects in a target area.

A further step 730 comprises selecting, based on the requirement, at least one device from a plurality of devices.

A further step 740 comprises collecting, from the at least one device, sensing data of the one or more target objects in the target area.

A further step 750 comprises processing the sensing data.

A further step 760 comprises transmitting the sensing data to the consumer entity.

In certain embodiments, the method 700 may be performed by a processor executing program code, for example, a microcontroller, a microprocessor, a CPU, a GPU, an auxiliary processing unit, a FPGA, or the like.

In some embodiments, the service request comprises a VAL server identifier or application server identifier or an SME identifier; a VAL service identifier or an application service identifier; a sensing event identifier; one or more VAL UE identifiers/addresses within a VAL service; the target area; a time validity/horizon; one or more quality of service requirements; one or more sensing requirements; identifiers for the one or more target objects to be sensed; an event reporting criteria; and/or a permission, restriction and/or preference for a sensor technology.

In some embodiments, the consumer entity is a VAL server.

In some embodiments, the consumer entity is a spatial mapping enabler, SME, or a spatial anchor enabler, SAE.

In some embodiments, the service request further comprises at least one of: a spatial mapping of, or data for spatially mapping, the target area; a request for sensor data for a particular user; a positional and/or orientation data for a particular user; and/or a request for sensor data related to a set of spatial anchors.

Some embodiments further comprise obtaining, from an object repository, one or more attributes relating to the one or more target objects in the target area.

Some embodiments comprise transmitting, to the object repository, a mapping of the sensing data to the one or more target objects.

Some embodiments comprise determining sensing capabilities of the plurality of devices, wherein the sensing capabilities relate to sensing the one or more target objects in the target area; and wherein the selecting the at least one device comprises performing the selection based also on the sensing capabilities.

In some embodiments, the sensing capabilities comprise respective sensing technologies of the plurality of devices, and wherein the selecting the at least one device further comprises determining a sensing technology for sensing the one or more target objects in the target area.

In some embodiments, the determining the sensing capabilities of the plurality of devices comprises querying a first network function for the sensing capabilities of the plurality of devices.

In some embodiments, the first network function is a network function selected from the list of network functions consisting of: an LMF; and a sensing function.

In some embodiments, the determining the sensing capabilities of the plurality of devices comprises: transmitting a query to the plurality of devices, the query requesting the sensing capabilities of the plurality of devices; and receiving a query response from one or more of the devices in the plurality of devices.

In some embodiments, the query to the plurality of devices, comprises: a VAL service identifier or application service identifier; one or more sensing requirements; identifiers for the one or more target objects to be sensed; a sensing preferences request; a device battery/context request; a target area; a time of interest; and/or a time to wait.

Some embodiments further comprise determining a feasibility of fulfilling the service request based on the sensing capabilities of the plurality of devices.

In some embodiments, the sensing data comprises: one or more identifiers related to the one or more target objects; a location related to the one or more target objects; a mobility related to the one or more target objects; an orientation related to the one or more target objects; a dimensional information related to the one or more target objects; and/or a material information related to the one or more target objects.

In some embodiments, the processing the sensed data comprises performing an abstraction, integration and/or fusion of the sensed data.

Some embodiments further comprise: collecting supplementary data related to the target area; and performing the abstraction, integration and/or fusion using both the sensed data the supplementary data.

In some embodiments, the processing the sensed data comprises performing object recognition.

The disclosure herein further provides a user equipment device in a wireless communication system, comprising a processor; and a memory coupled with the processor, the processor configured to cause the user equipment device to: receive, from an apparatus in the wireless communication system, a query requesting sensing capabilities; determine, based on the query, one or more sensing capabilities of the user equipment device and/or of one or more connected applications of the user equipment device; and then transmit, to the apparatus, a query response, wherein the query response comprises the determined one or more sensing capabilities.

In some embodiments, the query comprises: a VAL service ID or application service ID; one or more sensing requirements; identifiers for the one or more target objects to be sensed; a sensing preferences request; a device battery/context request;
a target area; a time of interest; and/or a time to wait.

FIG. 8 illustrates an embodiment 800 of a method in a user equipment device, the user equipment device in a wireless communication system.

A first step 810 comprises receiving, from an apparatus in the wireless communication system, a query requesting sensing capabilities.

A further step 820 comprises determining, based on the query, one or more sensing capabilities of the user equipment device and/or of one or more connected applications of the user equipment device.

A further step 830 comprises transmitting, to the apparatus, a query response, wherein the query response comprises the determined one or more sensing capabilities.

In certain embodiments, the method 800 may be performed by a processor executing program code, for example, a microcontroller, a microprocessor, a CPU, a GPU, an auxiliary processing unit, a FPGA, or the like.

In some embodiments, the query comprises: a VAL service ID or application service ID; one or more sensing requirements; identifiers for the one or more target objects to be sensed; a sensing preferences request; a device battery/context request;
a target area; a time of interest; and/or a time to wait.

FIG. 9 illustrates an embodiment 900 of sensing enablement for metaverse/AI/XR applications. This embodiment 900 describes a mechanism for sensing enablement (where sensing can be provided by multiple sources/technologies) from the UEs 961, 971 (which are assumed to deploy an enabler client 962, 972) and/or the network (if network deploys a sensor function 950). Such enablement service is consumed by the Meta/XR/AI applications which can use the sensing data (or fused data) for objects within a service area, to perform application layer actions (e.g. represent digital objects in a metaverse/XR world, enhance AI/ML services using sensing data as input).

Certain pre-conditions apply to the embodiment 900 illustrated in FIG. 9. In particular, that a Sensing Enabler Server (SES) 940 is authorized/in a trusted mobile network operator (MNO) domain to perform sensing enablement. Furthermore, that the SES 940 is connected with the Sensing Enabler Client (SEC) 962, 972, in its coverage area.

The embodiment 900 shows a VAL server 930 (XR, AI, Metaverse application), sensing enabler server (SES)/application function 940, LMF/sensing function 950 with NEF 951, a first grouping 960 comprising a UE 961, sensing enabler client 962 and XR application 963, and a second grouping 970 comprising a UE 971, a sensing enabler client 972, a sensing application 973, and an XR application 974. The various steps of sensing enablement in the embodiment 900 will now be described.

In a first step 901, the VAL server 930 sends a sensing enabler subscription request (or a request) to the SES 940. This is illustrated as a ‘sensing enabler subscription request’. This request includes sensing enablement requirements. The sensing enabling requirements may comprise a VAL server ID or App server ID, a VAL service identifier (e. g Meta Service number), a sensing event ID, one or more VAL UE identifiers/addresses within the VAL service, a service area where this subscription applies (this can be geographical or topological area), a time validity/horizon, QoS requirements for the VAL service, optionally one or more sensing requirements (such accuracy, delay), optionally a list of objects to be sensed, event reporting criteria (i.e. when to report the sensing data), and/or permissions/restrictions/preferences for the sensors to be used.

In a further step 902, the SES 940 authorizes the request and provides a sensing enabler subscription response back to the VAL server 930 as a positive or negative acknowledgement. This is illustrated as ‘sensing enabler subscription response’.

In a further step 903, the SES 940 translates the sensing enabler requirement in step 901 to a sensing requirement (if not already provided in step 901). This is illustrated as ‘translate VAL service requirement to sensing requirement (identify objects)’. This includes the determination of the sensing area (topological) and the sensing technologies to be considered. Also, this triggers the queries towards the network 950 and UEs 961 and 971. This is illustrated as ‘trigger queries to network and UEs’.

In a further step 904a, the SES 940, acting as AF, sends a query to the underlying 5G core network (LMF or sensing function 950), to receive the sensing capabilities for the target area or for one or more target objects. This is illustrated as ‘query sensing capabilities per application/UE for target service area’. In a further step 904b the 5G core network (LMF or sensing function 950) sends the sensing capabilities/configurations back to the SES 940. This is illustrated as ‘sensing capabilities’.

In a further step 905a, the SES 940 also broadcasts (or sends to the list of UEs in groupcast or via unicast transmission modes) to the target service area (based on the area of interest in step 901) a query to identify possible sensing sources and capabilities at the VAL UEs 961 and 971. This is illustrated as ‘broadcast query for sensing capabilities’. This query includes VAL service ID, sensor capabilities requirement (non-3GPP, 3GPP), object(s) identifiers/names, sensing preferences request, UE battery/context request, area of interest and time of interest/horizon, time to wait (for response).

In a further step 905b, the recipient SECs 962, 972 check with the connected applications 963, 973, 974 and the UE 961, 971 modems, to identify sensing capabilities based on the query. This is illustrated as ‘check sensing capabilities (from UE and applications)’.

In a further step 905c, the SECs 962, 972 send to the SES 940 the requested information including the sensing capabilities, preferences, UE battery. This is illustrated as, ‘sensing capability response’.

In a further step 906, the SES 940 determines for the given VAL service/Event ID (or per given object) the sensors to be used in the given area (this may include LiDAR sensing from UE 961, RF sensing from UE 971, for instance). This is illustrated as, ‘determine sensing UE(s) and sensors to be used for the VAL service/service area to fulfil the requirement’.

In a further step, the SES 940 collects the sensing outputs from the determined sources. This may be in form of request 907a/response 907b or subscribe 907a/notify 907b model. These steps are illustrated as, ‘requesting/subscribing for sensing data’ and ‘sensing data response/notify’. Such sensing output may include identified objects and their location/mobility/orientation or can be just the identification of an obstacle at a given location with certain attributes (e.g. height, material). The sensing 920 is shown as being performed across the groupings 960 and 970. As discussed herein, this may comprise the use of sensors to detect, measure and/or determine attributes of objects in a given service/target area. This may involve passive and/or active sensing and sensors, utilizing 3GPP and non-3GPP methods. Furthermore, this may involve the use of cameras, LIDAR, radar, sensors, by way of example.

In a further step 908, the SES 940 optionally may collect additional data related to the environment from the application layer 930 (e.g. meta SP). Such data can be HD or spatial maps that could help in identifying the exact object or improve accuracy. This is illustrated as ‘obtain supplementary data (maps, object information)’.

In a further step, the SES 909 performs sensing processing/abstraction/integration or fusion based on steps 907-908.

In a further step, the SES 910 sends the sensing outputs to the consumer application 930.

FIG. 10 illustrates an embodiment 10000 of sensing integration for a spatial mapping enablement service. This embodiment 10000 describes a mechanism for sensing enablement (where sensing can be provided by multiple sources/technologies) from the UEs 1061, 1071 (which are assumed to deploy an enabler client 1062, 1072) and/or the network (if network deploys a sensor function 1050), to be utilized by the sensing mapping/anchor enabler 1030.

In the spatial mapping use case (as described in 3GPP report TR 22.856), a spatial mapping enabler 1030 will help with classifying objects into modelling, and tracking of stationary and moving objects. For a stationary object, spatial mapping has to estimate the number of objects, type of object and position. Whereas for moving objects, spatial mapping has to determine the position, type of object, direction, speed. Once the spatial mapping service has sufficient information, it has to map all the stationary and moving objects related to a given UE's environment.

In the spatial anchor use case (as described in 3GPP report TR 22.856), the overall purpose of this enabler 1030 is to make it possible to create augmented reality (AR) content and share it with others. The ‘spatial anchor producer’ determines what to share and its location, and any constraints (e.g. who to share the spatial anchor with) and additional information, most importantly the ‘resource’ associated with the anchor (e.g. AR media, service to access, etc.). The ‘spatial anchor consumer’ is able to recognize anchors associated with locations and use the spatial anchor to obtain the associated information. Spatial anchor enablers 1030 will support the discovery of spatial anchors by the consumer.

Certain pre-conditions apply to the embodiment 1000 of FIG. 10. In particular, sensing enabler server (SES) 1040 is authorized/in trusted MNO domain to perform sensing enablement. Furthermore, the SES 1040 is connected with the sensing enabler client (SEC) 1062, 1072, in its coverage area.

The embodiment 1000 shows entities comprising a spatial mapping/anchor enabler 1030, an SES 1040, an LMF/sensing function 1050 with NEF 1051, a first grouping 1060 comprising a UE 1061, sensing enabler client 1062 and XR application 1063, a second grouping 1070 comprising a UE 1071, a sensing enabler client 1072, a sensing application 1073 and an XR application 1074, and a digital object repository 1080. Various steps illustrated in the embodiment 1000 of FIG. 10 will now be described in relation to these entities.

In a first step 1001, the Spatial Mapping Enabler (SME)/Spatial Anchor Enabler (SAE) 1030 sends a subscription request (or a request) to the SES 1040. This is illustrated as ‘sensing enabler subscription request (list of objects information, spatial map, target area). This request includes the sensing enablement requirements of a VAL server ID or App server ID or SME ID, a VAL service identifier, one or more VAL UE identifiers/addresses within the VAL service, a service area where this subscription applies (this can be geographical or topological area), a time validity/horizon, QoS requirements for the VAL service, optionally one or more sensing requirements (accuracy, delay), IDs for a list of objects to be sensed, event reporting criteria (when to report the sensing data), and/or permissions/restrictions/preferences for the sensors to be used. Furthermore, the sensing enablement requirements in the request/subscription may further comprise, for a consumer 1030 that is an SME, sensor data for the target area (e.g. objects) needed for the spatial mapping (if no map exists) or (if spatial map exists) the spatial mapping, a request for sensor data for particular users, or data used to identify in 3D space the position, viewing direction, angle, etc. of the user. Or, if the consumer 1030 is an SAE, a request for sensor data related to the set of spatial anchors (objects) in a given area.

In a further step 1002, the SES 1040 authorizes the request and provides a subscription response as a positive or negative acknowledgement. This is illustrated as, ‘sensing enabler subscription response’.

In a further step 1003, the SES 1040 may also request and receive from an object repository 1080 (at edge/cloud/core) information/attributes for one or more object IDs (based on step 1001). This information may include attributes/ characteristics/profile for the object to be sensed. This is illustrated as, ‘request/receive object attributes (object ID, name, type, static/moving, height’.

In a further step 1004, the SES 1040 translates the sensing enabler requirement in step 901 to one or more sensing requirements. This includes the determination of the sensing area (topological) and the sensing technologies to be considered, as well as the objects to be sensed (spatial anchors or target objects/UEs for the spatial mapping case). Also, this triggers the queries towards the network 1050/1051 and UEs 1061/1071. This step 1004 is illustrated as, ‘determine objects to identify, determine sensing requirements’.

In a further step 1005, the steps 904-905 of FIG. 9 are performed.

In a further step 1006, the SES 1040 determines for the given enablement service (SME, SAE)/Event ID (or per given object) the sensors to be used in the given area (this may include LiDAR sensing from UE 1061, RF sensing from UE 1071, for instance). This is illustrated as, ‘determine sensing UE(s) and sensors to be used for the required objects in the target service/area’.

In a further step, the SES 1040 collects the sensing outputs from the determined sources. This may be in form of request 1007a/response 1007b or subscribe 1007a/notify 1007b model. Such sensing output may include identified objects and their location/mobility/orientation or can be just the identification of an obstacle at a given location with certain attributes (e.g. height, material). In some cases, the sensing outputs may not identify an object but provide location for an object with certain attributes/characteristics. The steps 1007a and 1007b are illustrated as, ‘sensing data request/subscribe (object ID or object attributes of interest)’ and ‘sensing data response/notify (object ID or object attributes of interest, sensing data/object position’ respectively. The sensing 1020 performed by the UEs 1061, 1071 and their connected applications 1063, 1073, 1074, is also illustrated in the Figure.

In a further step 1008, the SES 1040 performs sensing processing/abstraction/ integration or fusion based on step 1007 and the sensing output. This step also optionally includes the identification of the object based on the attributes and the mapping of the sensing data to the determined object. This is illustrated as ‘sensing fusion/processing, identifying type of object(s), mapping of type of object to the sensing data’.

In a further step 1009, the SES 1040 sends the sensing outputs to the consumer 1030 SME or SAE In a further optional step 1010, the SES 1040 sends also the mapping of the sensing data to the object, to the object repository 1080.

The disclosure herein relates to the problem of how to configure the sensors/sensing technologies to be used by one or more devices at a target service area for a particular metaverse/XR/AI service. In particular, how to decide and perform sensing fusion (when different types of sensors can be used) to allow the meeting of the application service requirements, while also ensuring efficient use of the network resources and having minimum impact on the device side.

The invention disclosed herein provides a mechanism for translating application requirement/s to sensing requirement/s, for querying the sensing capabilities (such as UE devices and network entities) in a target area and determining the sensors (3GPP sensors and non-3GPP sensors) to be used for a given application service. This mechanism also includes the processing/sensing fusion at the enablement layer, considering inputs from the UEs, applications and the network side.

Prior solutions do not enable sensing fusion from heterogenous sources at the application layer, and do not access in real time the sensing capabilities of the UEs, to decide the sensing needed.

The disclosure herein provides an embodiment that describes a mechanism for a sensing enablement SA6 service. Such a service is consumed by metaverse/XR/AI applications which can use the sensing data (or fused data) for objects within a service area, to perform application layer actions (e.g. represent digital objects in a metaverse/XR world, and enhance AI/machine learning (ML) services using sensing data as an input). Furthermore, the disclosure herein provides an embodiment that describes a mechanism for sensing enablement (where sensing can be provided by multiple sources/technologies) from the UEs (which are assumed to deploy an enabler client) and/or the network (if network deploys a sensor function), to be utilized by a sensing mapping/anchor enabler.

The disclosure herein provides, a method for sensing enablement, the method comprising: obtaining an application service requirement from a consumer application; mapping the application service requirement to a requirement for sensing one or more objects in a target area; querying the capabilities of a plurality of devices, wherein the capabilities are related to sensing the one or more objects in a target area; determining one or more devices from the plurality of devices, for sensing the one or more objects in the target area, wherein determining the one or more devices comprises determining the sensing methods to be used; collecting sensing data from the determined one or more devices; processing the collected sensing data; sending the sensing data to the consumer application.

In some embodiments the application service requirement comprises a needed QoS/QoE for the service, the role of the service enabler to provide sensing data or fused sensing data, or the role of the service enabler to provide a value added service related to sensing (for example spatial mapping). The requirement may relate to a XR/AI/metaverse application. The application service requirement may further comprise sensing enabling requirements including, but not limited to, a VAL server ID or application server ID, a VAL service identifier (e.g. a metaverse service), a sensing event ID, one or more VAL UE identifiers/addresses within a VAL service, a service area where the service requirement applies (which may be geographical or topological area), a time validity/horizon, sensing requirements (such as accuracy, delay, for instance), a list of objects to be sensed, event reporting criteria (i.e. when to report sensing data), and/or permissions/restrictions/preferences for the sensors to be used.

In some embodiments, querying the capabilities of a plurality of devices comprises requesting capabilities and preferences related to sensing; and receiving the requested VAL UE/user capabilities and preferences.

In some embodiments the method further comprises querying at least one network entity on the capabilities related to a plurality of devices in a service area.

In some embodiments, the sensing methods comprise sensing from one or more sensor types, in particular lidar and/or camera.

In some embodiments, the method further comprises evaluating the feasibility of fulfilling the application service requirement based on the received sensing capabilities.

In some embodiments, the processing of collected sensing data is a fusion and/or abstraction of the sensing data.

In some embodiments, the method further comprises obtaining supplementary data.

The methods disclosed herein may in particular be utilized in relation to spatial anchors/mapping.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communication standards, these examples are not intended to be the limit of the communication standards to which the disclosed method and apparatus may be applied. For example, while specific examples have been given in the context of 3GPP, the principles disclosed herein can also be applied to another wireless communication system, and indeed any communication system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations are relevant in the field addressed by this document: AF, Application Function; XR, Extended Reality; SME, Spatial Mapping Enabler; SAE, Spatial Anchor Enabler; SES, Sensing Enabler Server; SEC, Sensing Enabler Client; and UWB, Ultra Wideband.

1. An apparatus for wireless communication, comprising:
at least one memory; and
at least one processor coupled with the at least one memory and configured to cause the apparatus to:
receive from a consumer entity, a service request;
determine, based on the service request, a requirement for sensing one or more target objects in a target area;
select, based on the requirement, at least one device from a plurality of devices;
collect, from the at least one device, sensing data of the one or more target objects in the target area;
process the sensing data; and
transmit the sensing data to the consumer entity.

2. The apparatus of claim 1, wherein the service request comprises:
a vertical application layer (VAL) server identifier, application server identifier, or a spatial mapping enabler (SME) identifier;
a VAL service identifier of an application service identifier;
a sensing event identifier;
one or more VAL user equipment (UE) identifiers/addresses within a VAL service;
the target area;
a time validity/horizon;
one or more quality of service requirements;
one or more sensing requirements;
identifiers for the one or more target objects to be sensed;
an event reporting criteria; or
a permission, restriction, or preference for a sensor technology.

3. The apparatus of claim 2, wherein the consumer entity is a VAL server.

4. The apparatus of claim 1, wherein the consumer entity is a spatial mapping enabler (SME) or a spatial anchor enabler (SAE).

5. The apparatus of claim 4, wherein the service request further comprises at least one of:
a spatial mapping or data for spatially mapping of the target area;
a request for sensor data for a particular user;
a positional oe orientation data for a particular user; or
a request for sensor data related to a set of spatial anchors.

6. The apparatus of claim 4, wherein the at least one processor is further configured to cause the apparatus to obtain, from an object repository, one or more attributes relating to the one or more target objects in the target area.

7. The apparatus of claim 6, wherein the at least one processor is further configured to cause the apparatus to transmit, to the object repository, a mapping of the sensing data to the one or more target objects.

8. The apparatus of claim 1, wherein the at least one processor is further configured to cause the apparatus to:
determine sensing capabilities of the plurality of devices, wherein the sensing capabilities relate to sensing the one or more target objects in the target area; and
select the at least one device based on the sensing capabilities.

9. The apparatus of claim 8, wherein the sensing capabilities comprise respective sensing technologies of the plurality of devices, and wherein the at least one processor is further configured to cause the apparatus to select the at least one device and determine a sensing technology for sensing the one or more target objects in the target area.

10. The apparatus of claim 8, wherein, to determine the sensing capabilities of the plurality of devices, the at least one processor is further configured to cause the apparatus to:
query a first network function for the sensing capabilities of the plurality of devices.

11. The apparatus of claim 10, wherein the first network function is
a location management function (LMF); or
a sensing function.

12. The apparatus of claim 8, wherein, to determine the sensing capabilities of the plurality of devices, the at least one processor is further configured to cause the apparatus to:
transmit a query to the plurality of devices, wherein the query includes a request for the sensing capabilities of the plurality of devices; and
receive a query response from one or more of the devices in the plurality of devices.

13. The apparatus of claim 12, wherein the query includes:
a VAL service ID or application service ID;
one or more sensing requirements;
identifiers for the one or more target objects to be sensed;
a sensing preferences request;
a device battery/context request;
a target area;
a time of interest; or
a time to wait.

14. The apparatus of claim 8, wherein the at least one processor is further configured to cause the apparatus to determine a feasibility of fulfilling the service request based on the sensing capabilities of the plurality of devices.

15. The apparatus of claim 1, wherein the sensing data comprises:
one or more identifiers related to the one or more target objects;
a location related to the one or more target objects;
a mobility related to the one or more target objects;
an orientation related to the one or more target objects;
a dimensional information related to the one or more target objects; or
a material information related to the one or more target objects.

16. The apparatus of claim 1, wherein the at least one processor is further configured to cause the apparatus to process the sensed data by performing an abstraction, integration, or fusion of the sensed data.

17-18. (canceled)

19. A user equipment (UE) for wireless communication, comprising:
at least one memory; and
at least one processor coupled with the at least one memory and configured to cause the UE to:
receive, from an apparatus in a wireless communication system, a query that includes a request for sensing capabilities of the UE;
determine, based on the query, one or more sensing capabilities of the UE or one or more connected applications of the UE; and
transmit, to the apparatus, a query response, wherein the query response comprises the determined one or more sensing capabilities of the UE.

20. The UE of claim 19, wherein the query includes:
a vertical application layer (VAL) service ID or application service ID;
one or more sensing requirements;
identifiers for one or more target objects to be sensed;
a sensing preferences request;
a device battery/context request;
a target area;
a time of interest; or
a time to wait.

21. A method performed by an apparatus in a wireless communication system, the method comprising:
receiving from a consumer entity, a service request;
determining, based on the service request, a requirement for sensing one or more target objects in a target area;
selecting, based on the requirement, at least one device from a plurality of devices;
collecting, from the at least one device, sensing data of the one or more target objects in the target area;
processing the sensing data; and
transmitting the sensing data to the consumer entity.

22-38. (canceled)

39. A method performed by a user equipment (UE), the method comprising:
receiving, from an apparatus in a wireless communication system, a query that includes a request for sensing capabilities of the UE;
determining, based on the query, one or more sensing capabilities of the UE or of one or more connected applications of the UE; and
transmitting, to the apparatus, a query response, wherein the query response comprises the determined one or more sensing capabilities of the UE.
